(19) United States
(12) Patent Application Publication
(10) Pub. No.: US 2006/0124767 A1
(43) Pub. Date: Jun. 15, 2006

(54) Leakage proof device for a sprinkler nozzle

(75) Inventors: Po-Hsiung Wang, Miao-Li Hsien (TW); Tzu-Meng Wang, Miao-Li Hsien (TW)

Correspondence Address: DELLETT & WALTERS, P. O. BOX 82788, PORTLAND, OR, 97282-0788, US

(73) Assignee: KWAN-TEN ENTERPRISE CO., LTD.

(21) Appl. No.: 11/011,795

(22) Filed: Dec. 13, 2004

(51) Int. Cl. B05B 15/06; B05B 15/10; A01G 25/06

(52) U.S. Cl. 239/200; 239/201; 239/203

(57) ABSTRACT

A leakage proof device for a sprinkler nozzle includes a flange adapted to be formed on a peripheral edge of the isolator, an annular wall adapted to be formed on a peripheral edge of the controlling disk to be on top of arcuate seats which are formed on an inner side of the controlling disk and an O ring sandwiched between the flange and the annular wall to stop leakage between the isolator and the controlling disk.

### BACKGROUND OF THE INVENTION

1. Field of the Invention

The present invention relates to a leakage proof device, and more particularly to the leakage proof device for a sprinkler nozzle to enable the sprinkler nozzle to temporarily withhold water when in application.

2. Description of Related Art

With reference to FIGS. 5 and 6, a conventional sprinkler head is composed of a cup-like body (4), an isolator (5) and a controlling disk (6).

The body (4) has a first end for connection to a water source and a second end provided with an inlet (41). The isolator (5) includes an outlet (50), multiple stops (51) formed on a side face thereof, multiple seals (52) inserted into the stops (51), a centrally defined assembly hole (53) and a recess (54) defined in a side periphery of the isolator (5) to receive therein a spring-ball combination (55).

The controlling disk (6) has multiple through holes (61) defined through the controlling disk (6) to respectively and selectively communicate with the outlet (50) of the isolator (5) and multiple arcuate seats (62) formed on an inner face of the controlling disk (6) to correspond to the spring-ball combination (55).

After the conventional sprinkler nozzle is assembled, it is appreciated that the inlet (41) is in communication with the outlet (50) at all times so that when there is water coming from the inlet (41), the water will flow out of the outlet (50) and to one of the through holes (61) of the controlling disk (6). When the user wishes to change the water sprinkling pattern or the water sprinkling volume, the user is able to rotate the controlling disk (6) relative to the isolator (5) so as to allow a specific through hole (61) to be aligned with the outlet (50) of the isolator (5). However, before the alignment between the specific through hole (61) and the outlet (50) is reached, water still flows out of the outlet (50), which causes the water to flow backward from the controlling disk (6) and eventually the water will leak from a gap between the controlling disk (6) and the isolator (5). When the sprinkler nozzle starts to leak, the user will experience inconvenience and delay in accomplishing the intended task.

To overcome the shortcomings, the present invention tends to provide an improved leakage proof device to mitigate the aforementioned problems.

### SUMMARY OF THE INVENTION

The primary objective of the present invention is to provide a leakage proof device to temporarily withhold water flow before the alignment of one of the through holes of the controlling disk to the outlet of the isolator is achieved.

In order to accomplish the aforementioned objective, the leakage proof device of the present invention includes a flange formed on a peripheral edge of the isolator, an annular wall formed on a peripheral wall of the controlling disk and an O ring sandwiched between the flange and the annular wall such that before the alignment between one of the through holes of the controlling disk and the outlet of the isolator is achieved, the sprinkler nozzle is able to withhold water inside the sprinkler nozzle.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the sprinkler nozzle of the present invention;

FIG. 2 is a cross sectional view of the assembled sprinkler nozzle in FIG. 1;

FIGS. 3 and 4 are schematic views showing movement of the controlling disk relative to the isolator;

FIG. 5 is an exploded perspective view of a conventional sprinkler nozzle; and

FIG. 6 is a cross sectional view of the sprinkler nozzle in FIG. 5.

### DETAILED DESCRIPTION OF THE PREFERRED EMBODIMENT

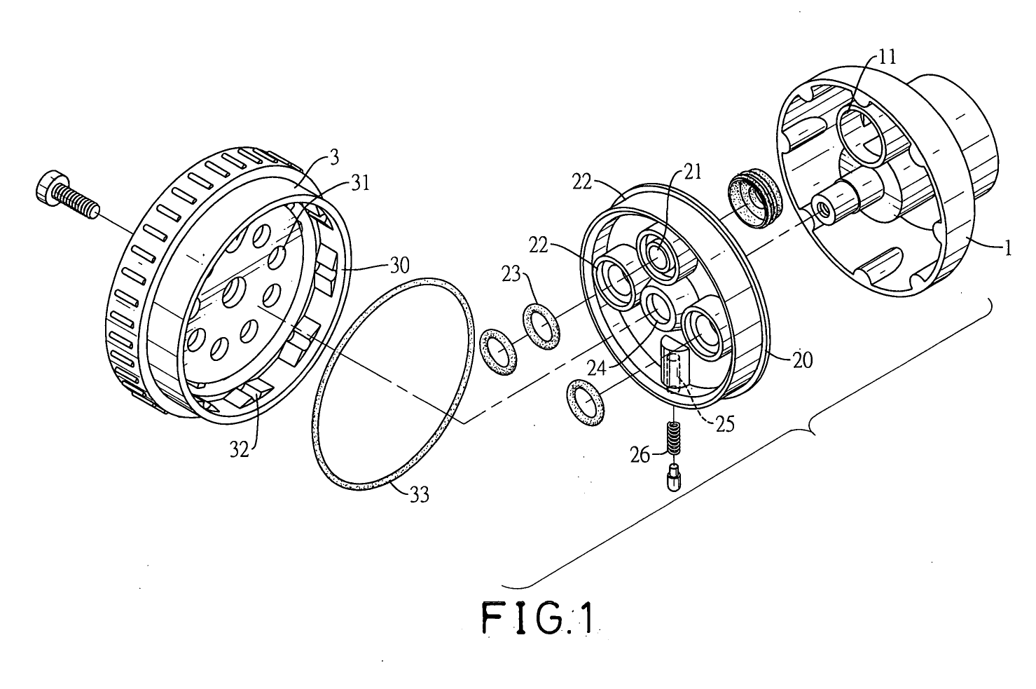

With reference to FIG. 1, the sprinkler nozzle of the present invention includes a cup-like body (1), an isolator (2) and a controlling disk (3).

The body (1) has a first end for connection to a water source and a second end provided with an inlet (11). The isolator (2) includes an outlet (21), multiple stops (22) formed on a side face thereof, multiple seals (23) inserted into the stops (22), a centrally defined assembly hole (24) and a recess (25) defined in a side periphery of the isolator (2) to receive therein a spring-ball combination (26).

The controlling disk (3) has multiple through holes (31) defined through the controlling disk (3) to respectively and selectively communicate with the outlet (21) of the isolator (2) and multiple arcuate seats (32) formed on an inner face of the controlling disk (3) to correspond to the spring-ball combination (26).

Furthermore, the isolator (2) has a flange (20) formed on a peripheral edge of the isolator (2) and the controlling disk (3) has an annular wall (30) formed on a peripheral edge of the controlling disk (3) and above the arcuate seats (32). An O ring (33) is provided between the flange (20) and the annular wall (30).

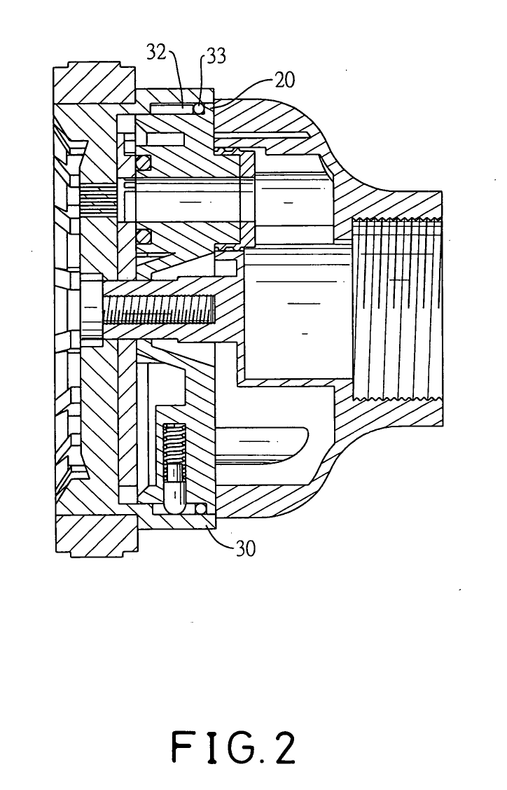

With reference to FIG. 2, it is noted that after the sprinkler nozzle of the present invention is assembled, the O ring (33) is sandwiched between the flange (20) of the isolator (2) and the annular wall (30) of the controlling disk (3) and supported by the arcuate seats (32).

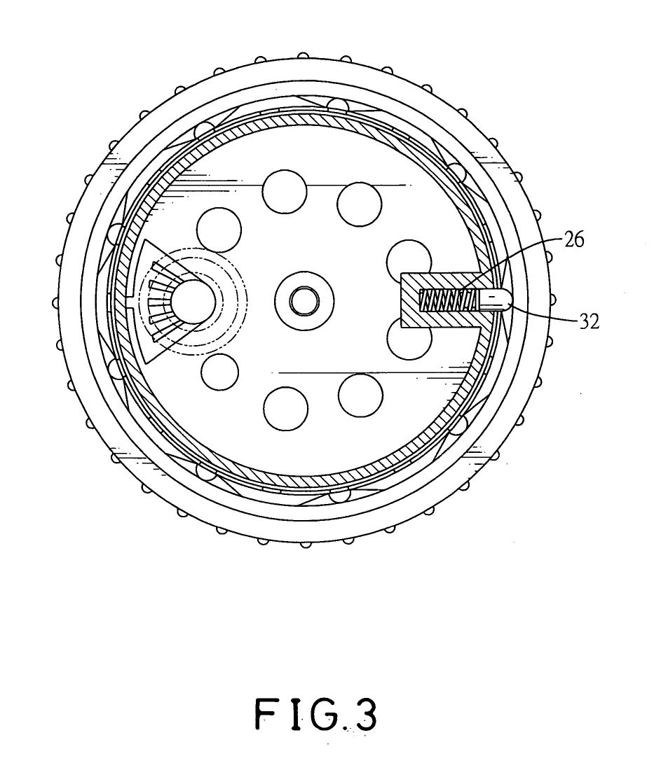

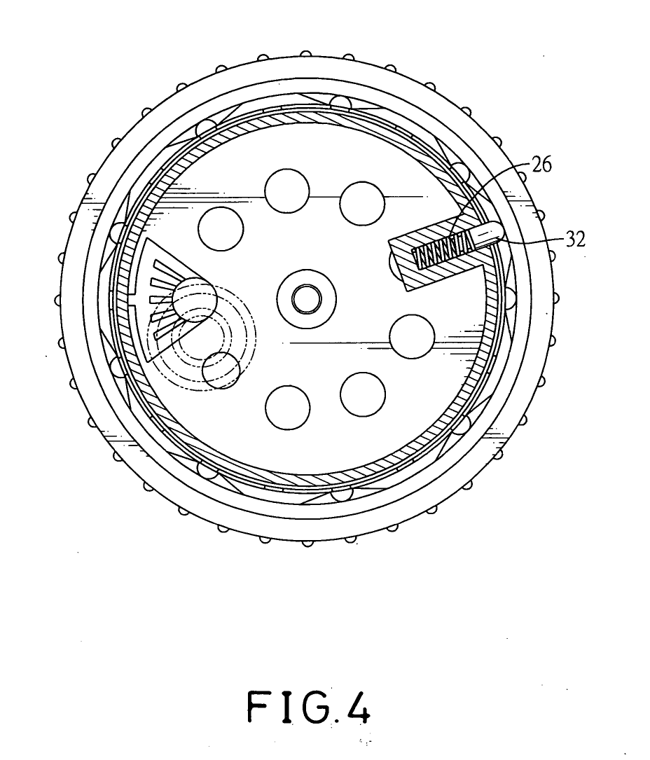

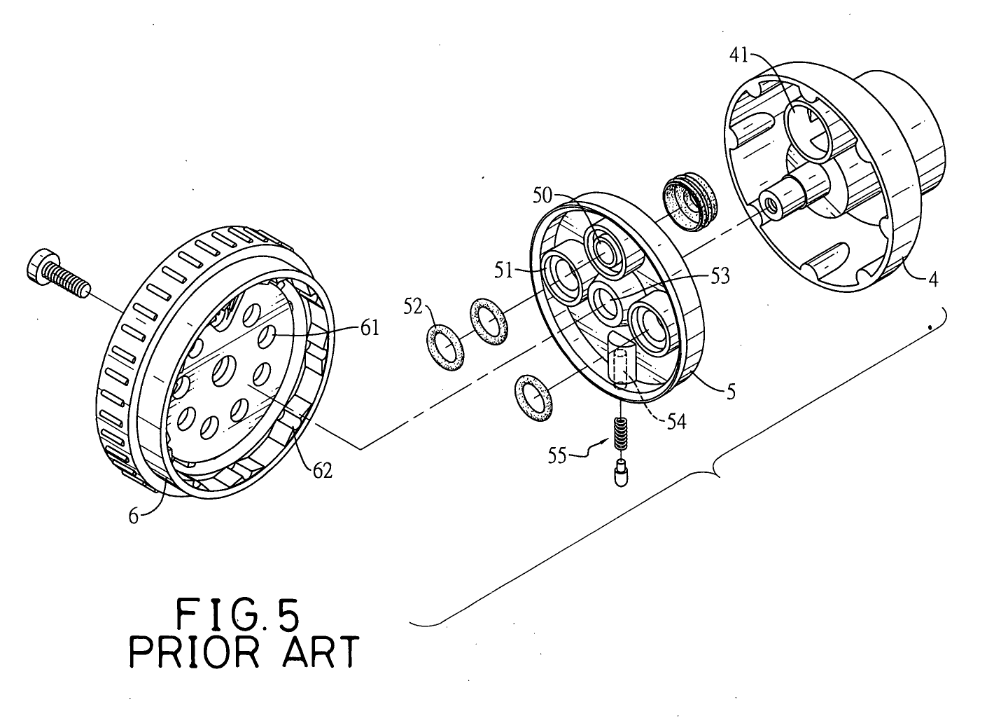

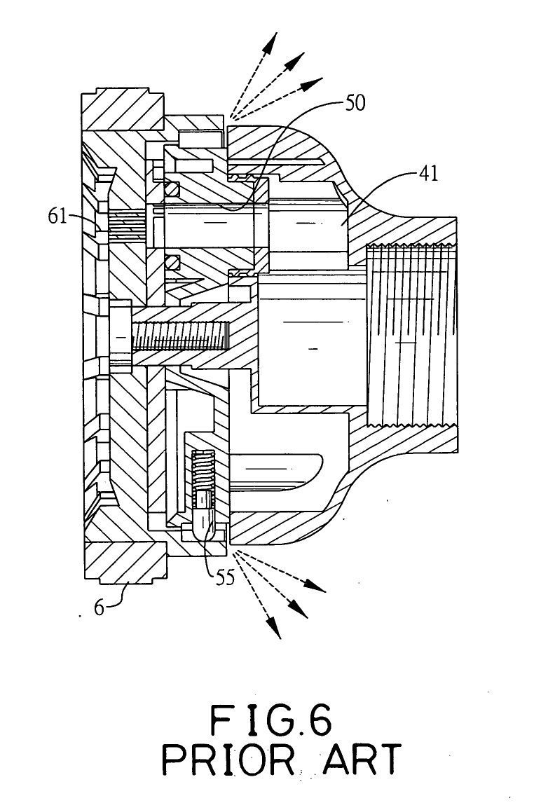

With reference to FIGS. 3 and 4, it is noted that when the spring-ball combination (26) is received in a corresponding one of the arcuate seats (32), the outlet (21) is in communication with one of the through holes (31) and water coming out of the outlet (21) is able to flow out of the respective through hole (31). However, when the spring-ball combination (26) is not rested in any one of the arcuate seats (32), the outlet (21) is not in communication with any one of the through holes (31) such that there is no escape for the water and the water starts to flow backward to the isolator (2). Because of the provision of the flange (20), the annular wall (30) and the O ring (33) sandwiched between the flange (20) and the annular wall (30) and supported by the arcuate seats (32), water is temporarily withheld inside the sprinkler nozzle and leakage from the sprinkler nozzle is avoided.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A leakage proof device for a sprinkler nozzle having a body, a controlling disk and an isolator sandwiched between the body and the controlling disk, the leakage proof device comprising:
a flange adapted to be formed on a peripheral edge of the isolator;
an annular wall adapted to be formed on a peripheral edge of the controlling disk to be on top of arcuate seats which are formed on an inner side of the controlling disk; and
an O ring sandwiched between the flange and the annular wall to be supported by the arcuate seat to stop leakage between the isolator and the controlling disk.
